(19) United States
(12) Patent Application Publication
(10) Pub. No.: US 2024/0405928 A1
(43) Pub. Date: Dec. 5, 2024

(54) METHOD AND APPARATUS FOR HARQ-ACK FEEDBACK GENERATION PER DOWNLINK CONTROL INFORMATION

(71) Applicant: LENOVO (BEIJING) LIMITED, Beijing (CN)

(72) Inventors: Haipeng Lei, Beijing (CN); Yu Zhang, Beijing (CN)

(21) Appl. No.: 18/695,450

(22) PCT Filed: Sep. 28, 2021
(86) PCT No.: PCT/CN2021/121288

§ 371 Date: Mar. 26, 2024

(51) Int. Cl. H04L 1/1829; H04L 1/1812; H04L 5/00; H04W 72/232

(52) U.S. Cl. CPC H04L 1/1864; H04L 1/1812; H04L 1/1854; H04L 5/0055; H04W 72/232

(57) ABSTRACT

Embodiments of the present disclosure relate to HARQ-ACK codebook determination. According to some embodiments of the disclosure, a UE may receive a plurality of DCI formats. Each of the DCI formats may schedule at least one PDSCH transmission on at least one serving cell of the UE. The plurality of DCI formats may indicate the same slot for transmitting a HARQ-ACK codebook. The UE may generate the HARQ-ACK codebook according to various methods as disclosed in the present disclosure.

### TECHNICAL FIELD

Embodiments of the present disclosure generally relate to wireless communication technology, and more particularly to hybrid automatic repeat request acknowledgement (HARQ-ACK) codebook determination.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH). A UE may transmit hybrid automatic repeat request acknowledgement (HARQ-ACK) feedback (e.g., included in a HARQ-ACK codebook) corresponding to PDSCH transmissions through a physical uplink control channel (PUCCH) or a physical uplink shared channel (PUSCH).

There is a need for handling HARQ-ACK codebook determination in a wireless communication system.

### SUMMARY

Some embodiments of the present disclosure provide a user equipment (UE). The UE may include: a transceiver; and a processor coupled to the transceiver. The processor may be configured to: receive a plurality of downlink control information (DCI) formats, wherein each of the DCI formats schedules at least one physical downlink shared channel (PDSCH) transmission on at least one serving cell of the UE, and the plurality of DCI formats indicates a same slot for transmitting a hybrid automatic repeat request acknowledgement (HARQ-ACK) codebook; divide the plurality of DCI formats into a first set and a second set, wherein the first set includes all first type DCI formats of the plurality of DCI formats and the second set includes all second type DCI formats of the plurality of DCI formats, wherein each first type DCI format requires a single HARQ-ACK information bit and each second type DCI format requires more than one HARQ-ACK information bit, and wherein downlink assignment indicators (DAIs) are counted independently for the first type DCI format and the second type DCI format; generate a first HARQ-ACK sub-codebook comprising HARQ-ACK information bits for DCI formats in the first set arranged according to DAIs of the DCI formats in the first set; generate a second HARQ-ACK sub-codebook comprising HARQ-ACK information bits for DCI formats in the second set arranged according to DAIs of the DCI formats in the second set; and transmit the HARQ-ACK codebook comprising the first HARQ-ACK sub-codebook and the second HARQ-ACK sub-codebook.

Some embodiments of the present disclosure provide a base station (BS). The BS may include: a transceiver; and a processor coupled to the transceiver. The processor may be configured to: transmit, to a user equipment (UE), a plurality of downlink control information (DCI) formats, wherein each of the DCI formats schedules at least one physical downlink shared channel (PDSCH) transmission on at least one serving cell of the UE, and the plurality of DCI formats indicates a same slot for transmitting a hybrid automatic repeat request acknowledgement (HARQ-ACK) codebook; and receive, from the UE, the HARQ-ACK codebook comprising a first HARQ-ACK sub-codebook and a second HARQ-ACK sub-codebook, wherein the plurality of DCI formats is divided into a first set and a second set, the first set includes all first type DCI formats of the plurality of DCI formats and the second set includes all second type DCI formats of the plurality of DCI formats, wherein each first type DCI format requires a single HARQ-ACK information bit and each second type DCI format requires more than one HARQ-ACK information bit, wherein downlink assignment indicators (DAIs) are counted independently for the first type DCI format and the second type DCI format, and wherein the first HARQ-ACK sub-codebook comprises HARQ-ACK information bits for DCI formats in the first set arranged according to DAIs of the DCI formats in the first set, and the second HARQ-ACK sub-codebook comprises HARQ-ACK information bits for DCI formats in the second set arranged according to DAIs of the DCI formats in the second set.

The first type DCI format may be from a group of DCI formats including the following: a fallback DCI format; and a non-fallback DCI format transmitted on a carrier not configured with a code block group (CBG) based transmission, wherein the carrier is configured with a time domain resource allocation (TDRA) table with each entry indicating a single start and length indicator value (SLIV), or the carrier is configured with a TDRA table with at least one entry indicating a plurality of SLIVs and a single PDSCH is scheduled by the non-fallback DCI format, or the carrier is configured with a maximum of two transport blocks (TBs) per PDSCH and spatial bundling is applied.

The second type DCI format may be from a group of DCI formats including the following: a non-fallback DCI format transmitted on a carrier configured with a code block group (CBG) based transmission, or a carrier configured with a time domain resource allocation (TDRA) table with at least one entry indicating a plurality of start and length indicator values (SLIVs) and at least two PDSCHs are scheduled by the non-fallback DCI format, or a carrier configured with a maximum of two transport blocks (TBs) per PDSCH and no spatial bundling is applied.

In some embodiments of the present disclosure, the processor may be further configured to: determine a unified number of HARQ-ACK information bits per second type DCI format in the second set; and for each DCI format in the second set, determine a plurality of HARQ-ACK information bits for a corresponding DCI format in the second set from the second HARQ-ACK sub-codebook, wherein the size of the plurality of HARQ-ACK information bits is equal to the unified number.

In some embodiments, the unified number may be determined based on a scaling factor, the maximum number of PDSCHs schedulable by a DCI format, and the maximum number of code block groups (CBGs) per transport block (TB). In some examples, the scaling factor may be determined based on a probability of single-PDSCH scheduling, and the processor is further configured to transmit the scaling factor to the UE via radio resource control (RRC) signaling. In some examples, the scaling factor may be determined based on the maximum number of PDSCHs schedulable by a DCI format. In some examples, the scaling factor may be determined based on a time domain resource allocation (TDRA) table associated with the second set. In some embodiments, the processor may be further configured to transmit the unified number to the UE via radio resource control (RRC) signaling. In some embodiments, the value of the unified number may be equal to the minimum value of the maximum number of PDSCHs schedulable by a DCI format and the maximum number of code block groups (CBGs) per transport block (TB).

In some embodiments, in response to the corresponding DCI format scheduling a single PDSCH and the number of code block groups (CBGs) of the single PDSCH being greater than the unified number, or in response to the corresponding DCI format scheduling more than one PDSCH and the number of the more than one PDSCH being greater than the unified number, a HARQ-ACK bundling procedure may be performed on HARQ-ACK feedback for the corresponding DCI format to obtain the plurality of HARQ-ACK information bits.

During the HARQ-ACK bundling procedure, one of the following may be performed: bundling every first number consecutive bits of the HARQ-ACK feedback for the corresponding DCI format to a single bit, wherein the first number is determined based on the number of bits of the HARQ-ACK feedback for the corresponding DCI format and the unified number; iteratively bundling every 2 consecutive bits of the HARQ-ACK feedback for the corresponding DCI format to a single bit until the number of bundled bits is less than or equal to the unified number; bundling a second number of bits of the HARQ-ACK feedback for the corresponding DCI format to a single bit while keeping the remaining bits of the HARQ-ACK feedback for the corresponding DCI format unbundled to obtain the unified number of HARQ-ACK information bits; and in response to the unified number of HARQ-ACK information bits being greater than a third number of bits, bundling the second number of bits of the HARQ-ACK feedback for the corresponding DCI format to a single bit while keeping the remaining bits of the HARQ-ACK feedback for the corresponding DCI format unbundled to obtain the unified number of HARQ-ACK information bits; and in response to the unified number of HARQ-ACK information bits being less than or equal to the third number of bits, bundling every 2 consecutive bits of the HARQ-ACK feedback for the corresponding DCI format to a single bit to obtain the third number of bits and performing a bit bundling procedure among the third number of bits until the unified number of HARQ-ACK information bits accommodate the bundled bits, wherein the value of the third number is equal to the minimum integer which is greater than or equal to the quotient of the number of the generated HARQ-ACK information bits divided by 2.

During the bit bundling procedure among the third number of bits, one of the following may be performed: in response to the unified number of HARQ-ACK information bits being greater than a fourth number of bits, bundling a fifth number of bits of the third number of bits to a single bit while keeping the remaining bits of the third number of bits unbundled to obtain the unified number of HARQ-ACK information bits, wherein the value of the fourth number is equal to the minimum integer which is greater than or equal to the quotient of the third number divided by 2; and in response to the unified number of HARQ-ACK information bits being less than or equal to the fourth number of bits, bundling every 2 consecutive bits of the third number of bits to a single bit to obtain the fourth number of bits and perform the bit bundling procedure among the fourth number of bits until the unified number of HARQ-ACK information bits accommodate the bundled bits.

The value of the first number may be the minimum integer which is greater than or equal to the quotient of the number of bits of the HARQ-ACK feedback for the corresponding DCI format divided by the unified number. The value of the second number may be the sum of one and the difference between the number of bits of the HARQ-ACK feedback for the corresponding DCI format and the unified number. The second number of bits may be the starting or last second number of bits of the HARQ-ACK feedback for the corresponding DCI format.

In some embodiments, the plurality of HARQ-ACK information bits may include at least one padding bit such that the sum of the number of the bundled HARQ-ACK information bits for the corresponding DCI format and the number of the at least one padding bit is equal to the unified number.

In some embodiments of the present disclosure, the processor may be further configured to: transmit a semi-persistent scheduling (SPS) PDSCH; receive HARQ-ACK feedback corresponding to the SPS PDSCH in the HARQ-ACK codebook; wherein a HARQ-ACK information bit(s) for the SPS PDSCH is placed at the end or beginning of the first sub-codebook or at the end or beginning of the HARQ-ACK codebook; or wherein HARQ-ACK information bits for the SPS PDSCH are placed at the end or beginning of the second sub-codebook with the number of HARQ-ACK information bits for the SPS PDSCH aligned with a unified number of HARQ-ACK information bits per second type DCI format in the second set.

Some embodiments of the present disclosure provide a method for wireless communication performed by a user equipment (UE). The method may include: receiving a plurality of downlink control information (DCI) formats, wherein each of the DCI formats schedules at least one physical downlink shared channel (PDSCH) transmission on at least one serving cell of the UE, and the plurality of DCI formats indicates a same slot for transmitting a hybrid automatic repeat request acknowledgement (HARQ-ACK) codebook; dividing the plurality of DCI formats into a first set and a second set, wherein the first set includes all first type DCI formats of the plurality of DCI formats and the second set includes all second type DCI formats of the plurality of DCI formats, wherein each first type DCI format requires a single HARQ-ACK information bit and each second type DCI format requires more than one HARQ-ACK information bit, and wherein downlink assignment indicators (DAIs) are counted independently for the first type DCI format and the second type DCI format; generating a first HARQ-ACK sub-codebook comprising HARQ-ACK information bits for DCI formats in the first set arranged according to DAIs of the DCI formats in the first set; generating a second HARQ-ACK sub-codebook comprising HARQ-ACK information bits for DCI formats in the second set arranged according to DAIs of the DCI formats in the second set; and transmitting the HARQ-ACK codebook comprising the first HARQ-ACK sub-codebook and the second HARQ-ACK sub-codebook.

Some embodiments of the present disclosure provide a method for wireless communication performed by a base station (BS). The method may include: transmitting, to a user equipment (UE), a plurality of downlink control information (DCI) formats, wherein each of the DCI formats schedules at least one physical downlink shared channel (PDSCH) transmission on at least one serving cell of the UE, and the plurality of DCI formats indicates a same slot for transmitting a hybrid automatic repeat request acknowledgement (HARQ-ACK) codebook; and receiving, from the UE, the HARQ-ACK codebook comprising a first HARQ-ACK sub-codebook and a second HARQ-ACK sub-codebook, wherein the plurality of DCI formats is divided into a first set and a second set, the first set includes all first type DCI formats of the plurality of DCI formats and the second set includes all second type DCI formats of the plurality of DCI formats, wherein each first type DCI format requires a single HARQ-ACK information bit and each second type DCI format requires more than one HARQ-ACK information bit, wherein downlink assignment indicators (DAIs) are counted independently for the first type DCI format and the second type DCI format, and wherein the first HARQ-ACK sub-codebook comprises HARQ-ACK information bits for DCI formats in the first set arranged according to DAIs of the DCI formats in the first set, and the second HARQ-ACK sub-codebook comprises HARQ-ACK information bits for DCI formats in the second set arranged according to DAIs of the DCI formats in the second set.

Some embodiments of the present disclosure provide a UE. According to some embodiments of the present disclosure, the UE may include: a transceiver; and a processor coupled to the transceiver, wherein the transceiver and the processor may interact with each other so as to perform a method according to some embodiments of the present disclosure.

Some embodiments of the present disclosure provide a BS. According to some embodiments of the present disclosure, the BS may include: a transceiver; and a processor coupled to the transceiver, wherein the transceiver and the processor may interact with each other so as to perform a method according to some embodiments of the present disclosure.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of a DCI format scheduling a plurality of DL transmissions in accordance with some embodiments of the present disclosure;

FIG. 3 illustrates a schematic diagram of a plurality of DCI format transmissions in accordance with some embodiments of the present disclosure;

FIG. 4 illustrates a schematic diagram of HARQ-ACK codebook determination in accordance with some embodiments of the present disclosure;

FIG. 5 illustrates a flow chart of an exemplary procedure of wireless communications in accordance with some embodiments of the present disclosure;

FIG. 6 illustrates a flow chart of an exemplary procedure of wireless communications in accordance with some embodiments of the present disclosure; and

FIG. 7 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

FIG. 1 illustrates a schematic diagram of a wireless communication system 100 in accordance with some embodiments of the present disclosure.

As shown in FIG. 1, a wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

NR Release 17 is designed to expand the frequency range to 71 GHz. Due to the phase noise effect at a high frequency band, higher subcarrier spacing (SCS) may be specified for the purpose of reliability. For example, 120 kHz SCS, 240 kHz SCS, 480 kHz SCS, 960 kHz SCS, and 1920 kHz SCS may be considered. It is known that the higher the SCS, the shorter the duration of a slot. For example, Table 1 below shows exemplary slot durations for different SCSs. It should be understood that Table 1 is only for illustrative purposes, and should not be construed as limiting the embodiments of the present disclosure.

TABLE 1
Slot durations for different SCSs

| μ | Δf = 2^{μ} · 15[kHz] | Slot duration | |
|---|---|---|---|
| 0 | 15 | 1 | ms |
| 1 | 30 | 0.5 | ms |
| 2 | 60 | 0.25 | ms |
| 3 | 120 | 0.125 | ms |
| 4 | 240 | 0.0625 | ms |
| 5 | 480 | 31.25 | μs |
| 6 | 960 | 15.625 | μs |

In the above Table 1, the SCS configuration μ is associated with an SCS (listed in the second column of Table 1). For example, “μ=3” may indicate an SCS of 120 kHz, and the slot duration for such SCS is 0.125 ms.

As shown in the above table, the duration of one slot for, for example, 960 kHz SCS, 480 kHz SCS and 120 kHz SCS is quite short. So multiple consecutive slots may be within the coherent time of the wireless channel. In NR Release 17, multi-PDSCH and/or multi-PUSCH scheduling is supported. That is, a single DCI format may schedule a plurality of PDSCHs. In some examples, a maximum of 8 PDSCHs can be scheduled by a single DCI for, for example, 120 kHz SCS, 480 kHz SCS, and 960 kHz SCS. In some examples, a maximum of 8 PUSCHs can be scheduled by a single DCI for, for example, 120 kHz SCS, 480 kHz SCS, and 960 kHz SCS. Each PDSCH or PUSCH of the multiple PDSCHs or PUSCHs which are scheduled by a single DCI may carry a different transport block (TB). In some embodiments, a maximum number (e.g., 8) of PDSCHs that can be scheduled by a single DCI may be predefined in a standard(s). A UE may be configured, by a BS, with a specific maximum number (e.g., 6 or 8) of PDSCHs that may be scheduled by a DCI. The specific maximum number of PDSCHs may not exceed the predefined maximum number.

In the context of this disclosure, multi-PDSCH scheduling may refer to the case where multiple PDSCHs are scheduled by a single DCI that is associated with a time domain resource allocation (TDRA) table with at least one entry that allows scheduling more than one multiple PDSCHs. For example, at least one entry of the TDRA table may indicate a plurality of start and length indicator values (SLIVs). The above definition can be similarly applied to multi-PUSCH scheduling.

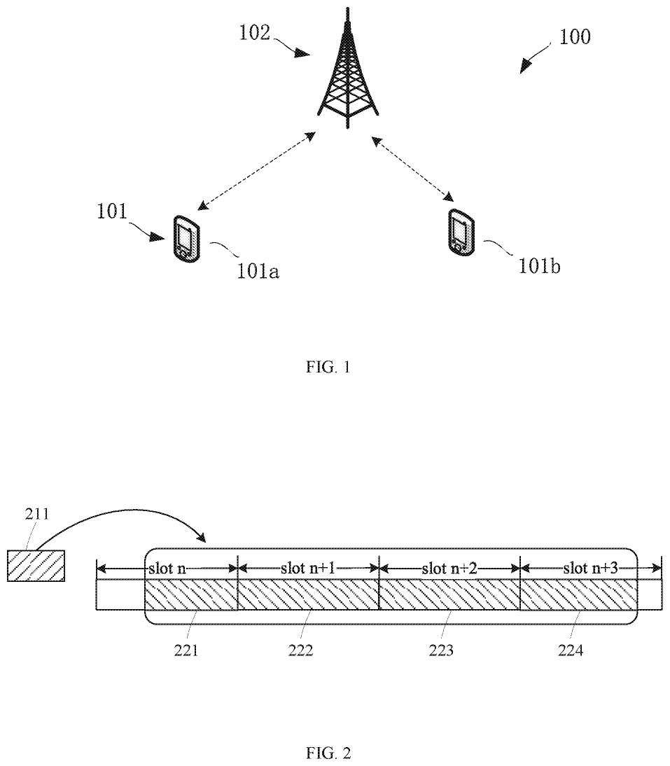

FIG. 2 illustrates a schematic diagram of a DCI format scheduling a plurality of DL transmissions in accordance with some embodiments of the present disclosure. As shown in FIG. 2, DCI format 211 may schedule four PDSCHs (e.g., PDSCHs 221-224) carrying four different TBs on multiple slots (e.g., slot n to slot n+3).

It should be understood that FIG. 2 is only for illustrative purposes, and should not be construed as limiting the embodiments of the present disclosure. For example, a DCI format may schedule fewer or more PDSCHs or a PUSCH in some other embodiments of the present disclosure.

The multi-slot PDSCH scheduling may cause HARQ-ACK codebook ambiguity between a UE and a BS when, for example, a DCI format scheduling multiple PDSCHs is missed by the UE.

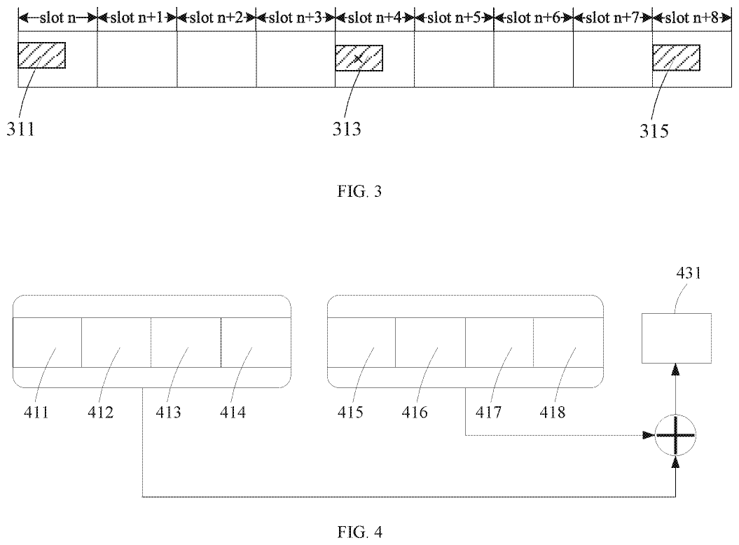

FIG. 3 illustrates a schematic diagram of a plurality of DCI format transmissions in accordance with some embodiments of the present disclosure. It should be understood that FIG. 3 is only for illustrative purposes, and should not be construed as limiting the embodiments of the present disclosure.

In FIG. 3, it is assumed that a UE is configured with a single serving cell and a dynamic HARQ-ACK codebook (also known as a “Type-2 HARQ-ACK codebook”). As shown in FIG. 3, a BS may transmit a plurality of DCI formats (e.g., DCI formats 311-315) to the UE. The downlink assignment indicators (DAIs) of DCI formats 311-315 may be 1 to 3, respectively. The BS may indicate that the HARQ-ACK feedback for a plurality of PDSCHs scheduled by the plurality of DCI formats is to be transmitted in the same slot.

Assuming that the UE receives only two DCI formats, for example, DCI formats 311 and 315, based on the respective downlink assignment indicators (DAIs) of DCI formats 311 and 315 (e.g., 1 and 3), the UE may identify that one DCI format (e.g., DCI format 313) is missed. When multi-PDSCH scheduling is supported, assuming that the UE is configured with a maximum of 8 PDSCHs schedulable by a single DCI format, the missed DCI format may schedule any number of PDSCHs from 1 PDSCH to 8 PDSCHs. In this scenario, the UE cannot figure out how many PDSCHs that are actually scheduled by the missed DCI format. As a result, the UE cannot determine the HARQ-ACK codebook.

In some embodiments of the present disclosure, the concept of code block group (CBG) is introduced to balance the number of the needed HARQ-ACK feedback bits and the retransmission efficiency. In general, the intention of employing the CBG is to group several code blocks into a code block group and generate the HARQ-ACK feedback per CBG. When all the code blocks within a CBG are correctly decoded, the HARQ-ACK feedback for the CBG can be set as “ACK”; otherwise, it is set as “negative ACK” (NACK). In response to the reception of the HARQ-ACK feedback, only the CBG(s) with “NACK” shall be retransmitted by the transmitter.

In some examples, RRC signaling may be used to configure the maximum number of CBGs per TB when CBG-based retransmission is employed. The maximum number of CBGs per TB can be, for example, 2, 4, 6 and 8. In some examples, for both the semi-static HARQ-ACK codebook (also known as “Type-1 HARQ-ACK codebook”) and the dynamic HARQ-ACK codebook, the number of HARQ-ACK bits for one TB may be equal to the configured maximum number of CBGs per TB, regardless of the variable TB size (TBS) of a given TB.

When both multi-PDSCH scheduling and CBG-based retransmission are supported on a serving cell, the problem of HARQ-ACK ambiguity between a UE and a BS due to a missed DCI may become even worse than only multi-PDSCH scheduling being supported on the serving cell since the number of HARQ-ACK information bits for the missed DCI may be dependent on the number of scheduled PDSCHs and the number of CBGs per TB. Furthermore, when extending the multi-PDSCH scheduling and CBG-based retransmission to carrier aggregation (CA) where multiple carriers are configured to a UE, different carriers may have different configurations on whether to support multi-PDSCH scheduling, the maximum number of PDSCHs schedulable by a single DCI format, and/or the maximum number of CBGs per TB. Clearly, HARQ-ACK codebook determination is quite complicated considering the above characteristics and functionalities, e.g., the CA case, multi-carrier scheduling and CBG-based retransmission.

Embodiments of the present disclosure provide solutions for HARQ-ACK codebook determination. For example, solutions for determining a HARQ-ACK codebook when multi-PDSCH scheduling is supported are proposed. More details on the embodiments of the present disclosure will be illustrated in the following text in combination with the appended drawings.

In some embodiments of the present disclosure, HARQ-ACK codebook construction may be dependent on the types of the DCI format. The first type DCI format is defined as the DCI format which requires a single HARQ-ACK information bit. The second type DCI format is defined as the DCI format which requires more than one HARQ-ACK information bit. DAIs may be counted independently for the first type DCI format and the second type DCI format. A unified number of HARQ-ACK information bits (denoted as “O”) may be generated for each second type DCI format.

All fallback DCI formats belong to the first type DCI format. Fallback DCI format may refer to the DCI format where the size of each field is predefined in a standard(s) irrespective of the RRC configuration. For example, DCI format 1_0 always belongs to the first type DCI format. No matter whether a DCI format 1_0 is transmitted on a carrier configured with a CBG-based transmission or not, no matter whether a DCI format 1_0 is transmitted on a carrier allowing multi-PDSCH scheduling (for example, the carrier is configured with a TDRA table including at least one entry with multiple SLIVs) or single-PDSCH scheduling (for example, the carrier is configured with a TDRA table including entries each with a single SLIV), and no matter whether a DCI format 1_0 is transmitted for a semi-persistent scheduling (SPS) PDSCH release or cell (e.g., SCell) dormancy without a scheduled PDSCH, these DCI formats 1_0 belong to the first type DCI format.

A non-fallback DCI format which requires a single HARQ-ACK information bit belongs to the first type DCI format. A non-fallback DCI format may refer to the DCI format where the size of at least one field is dependent on the RRC configuration. For example, a DCI format 1_1 or 1_2 transmitted on a carrier not configured with a CBG-based transmission, wherein the carrier is configured with a TDRA table with each entry indicating a single SLIV, or the carrier is configured with a TDRA table with at least one entry indicating a plurality of SLIVs and only a single PDSCH is scheduled by the DCI format, or the carrier is configured with a maximum of two TBs per PDSCH and spatial bundling is applied.

A non-fallback DCI format which requires more than one HARQ-ACK information bit belongs to the second type DCI format. For example, a DCI format 1_1 or 1_2 which is transmitted on a carrier configured with a CBG-based transmission, or a carrier configured with a TDRA table with at least one entry indicating a plurality of SLIVs and at least two PDSCHs are scheduled by the DCI format, or a carrier configured with a maximum of two TBs per PDSCH and no spatial bundling is applied.

The HARQ-ACK codebook may include two sub-codebooks. That is, a first sub-codebook includes HARQ-ACK information bits with each bit corresponding to a respective first type DCI format; and a second sub-codebook includes HARQ-ACK information bits with every 0 consecutive bits corresponding to a respective second type DCI format. The method for constructing such HARQ-ACK codebook will be described in detail in the following text. The HARQ-ACK codebook construction method described in the context of the subject disclosure can be applied to the single carrier case as well as the CA case.

A UE may receive a plurality of DCI formats, each of which may schedule at least one PDSCH on at least one serving cell of the UE. The plurality of DCI formats may indicate the same slot for transmitting a HARQ-ACK codebook. In a first step, the UE may divide the received DCI formats into a first set and a second set. The first set may include all the first type DCI formats of the plurality of DCI formats and the second set may include all the second type DCI formats of the plurality of DCI formats. Since DAIs are counted independently for the first type DCI format and the second type DCI format, DAIs are counted independently in the two sets.

In a second step, the UE may determine the unified number of HARQ-ACK information bits (e.g., O) per second type DCI format in the second set. The method for determining the value of O will be described in detail in the following text.

In a third step, the UE may generate a first HARQ-ACK sub-codebook including the HARQ-ACK information bits for the first type DCI formats according to the DAIs (e.g., counter DAIs) of the first type DCI formats in the first set. Since the first type DCI format requires a single HARQ-ACK information bit, no HARQ-ACK codebook ambiguity would occur when a first type DCI format is missed. The UE may generate a second HARQ-ACK sub-codebook including the HARQ-ACK information bits for the second type DCI formats according to the DAIs (e.g., counter DAIs) of the second type DCI formats in the second set. For each second type DCI format in the second set, O HARQ-ACK information bits may be generated.

In a fourth step, the UE may concatenate the two HARQ-ACK sub-codebooks as the HARQ-ACK codebook for transmitting to the BS. In some examples, the first sub-codebook may be placed in front of the second sub-codebook in the HARQ-ACK codebook. In some other examples, the second sub-codebook may be placed in front of the first sub-codebook in the HARQ-ACK codebook.

The unified number of HARQ-ACK information bits per the second type DCI format can be determined according to various methods, for example, predetermined based on an explicit configuration or implicit rules, so as to solve the problem of the missing second type DCI format. The number of transmitted first type DCI formats and the number of transmitted second type DCI formats can be separately determined based on the respective DAI of these DCI formats, for example, the respective total DAI in a CA case or the respective counter DAI in a single carrier case.

For either a single carrier in the single carrier case or a specific carrier among multiple carriers in the CA case, in the following text, M denotes the maximum number of PDSCHs which can be scheduled by a single DCI format, m denotes the number of PDSCHs actually scheduled by a DCI format, N denotes the configured maximum number of CBGs per TB, n denotes the number of actual CBGs of a single PDSCH scheduled by a DCI format, and O denotes the unified number of HARQ-ACK bits per second type DCI format.

The value of O can be determined according to one of the following methods. It should be understood that the following methods are only for illustrative purposes and should not be construed as limiting the embodiments of the present disclosure, persons skilled in the art can conceive of other methods for determining the value of O.

In some embodiments, a scaling factor of ρ may be introduced for determining the value of O. For example, the value of ρ may be determined to reach a tradeoff between M and N to save signaling overhead as much as possible. The value of O may be determined based on ρ, M, and N. For example, the value of O can be determined according to the below equation, which may be predefined:

$$O = ⌈ ρ * N + ( 1 - ρ ) * M ⌉ ,$$

$$0 \leq ρ \leq 1$$

Various methods may be employed to determine the value of ρ. In some examples, the value of ρ may be configured by radio resource control (RRC) signaling. For example, the value of ρ may correspond to the probability of a BS scheduling a single PDSCH by a single DCI format. In some examples, the probability can be estimated by a BS based on, for example, the channel condition and scheduling policy as well as scheduling history. The BS may then configure the value of ρ to a UE by RRC signaling. The UE can determine the value of O based on the configured ρ, M, and N and the above equation. For example, assuming M=8, N=4, and ρ=⅔, then O=5.

In some examples, considering that O=N only when m=1 and O=M as long as m>1, the probability of O=N is about 1/M. The value of ρ may be equal to 1/M. That is, the UE can determine the value of ρ based on the configured M. Then, the UE can determine the value of O based on ρ, M, and N and the above equation. For example, assuming M=6, N=4, then ρ=⅙, O=5.

In some examples, the value of ρ may be determined based on the configured TDRA table. For example, the value of ρ may be equal to the ratio between the number of entries with each entry indicating a single SLIV and the total number of entries of the TDRA table. For example, assuming the TDRA table may include 12 entries and 8 entries of the 12 entries indicate a single SLIV, then ρ=⅔ (8/12) and O=5.

In some embodiments, after determining the value of O according to the above equation, the value of O may be further refined. For example, the value of O may be refined to the nearest even number or the nearest power of 2, or the minimum even number which is equal to or larger than the value of O, or the maximum even number which is equal to or smaller than the value of O, or the minimum power of 2 which is equal to or larger than the value of O, or the maximum power of 2 which is equal to or smaller than the value of 0.

In some embodiments, the value of O may be determined to reach a tradeoff between M and N. For example, a BS may determine the value of O satisfying min(M, N)≤O≤max(M, N). The BS may configure the value of O to a UE by RRC signaling. In some embodiments, the value of O may be equal to the minimum value of M and N, i.e., O=min(M, N).

Considering the limited DCI format payload size, a single field of CBG transmission information (CBGTI) may be included in each second type DCI format.

When the number of PDSCHs actually scheduled by a second type DCI format is 1, N CBG-based HARQ-ACK feedback bits may be generated for the second type DCI format. When the number of actually scheduled by a second type DCI format is larger than 1, M HARQ-ACK feedback bits may be generated for the second type DCI format. Hence, for each second type DCI format, a size alignment may be needed to align the generated M or N bits to the unified number of HARQ-ACK bits (e.g., O) per second type DCI format.

When m=1, n HARQ-ACK information bits may be generated for the second type DCI format. If n=O, the final HARQ-ACK bits for the second type DCI format is the n bits. If n<O, O−n padding bits (e.g., NACK bits) may be added to the n bits (e.g., at the end or beginning of the n bits) so the final HARQ-ACK bits for the second type DCI format is the n bits plus O−n padding bits. If n>O, a HARQ-ACK bundling procedure may be performed.

When M>m>1, m HARQ-ACK information bits may be generated for the second type DCI format. If m=O, the final HARQ-ACK bits for the DCI format is the m bits. If m<O, O−m padding bits (e.g., NACK bits) may be added to the m bits (e.g., at the end or beginning of the m bits) so the final HARQ-ACK bits for the second type DCI format is the m bits plus O−m padding bits. If m>O, a HARQ-ACK bundling procedure may be performed.

Assuming x=n when m=1 or x=m when m>1, as mentioned above, when x>O, a HARQ-ACK bundling procedure may be performed to accommodate the generated x bits. For example, the HARQ-ACK bundling procedure may generate O bits for the second type DCI format based on the x bits and may include the O bits into the codebook for transmitting to the BS. Various methods may be employed to perform the HARQ-ACK bundling procedure.

In some embodiments, every Z consecutive bits of the generated HARQ-ACK information bits may be bundled to a single bit. The value of Z may be determined based on the values of x and O. For example, Z=┌x/O┐, then ┌x/Z┐ bundled bits may be generated. When the value of O is greater than the number of bundled bits, for example, O>┌x/Z┐, padding bits (e.g., NACK bits) may be added to the bundled bits until the number of bundled bits plus the padding bits is equal to 0.

For example, assuming that x=8, and {b0, b1, b2, b3, b4, b5, b6, b7} are the generated x HARQ-ACK information bits, when O=3, Z=3 and thus, every 3 consecutive bits may be bundled. Therefore, 3 bundled bits {b0&b1&b2, b3&b4&b5, b6&b7} may be obtained, where “&” represents a bundling operation such as a logic AND operation. Since the unified number of bits for the second type DCI format is 3, no padding bit is needed. In another example, when O=5, Z=2 and thus, every 2 consecutive bits may be bundled. Therefore, 4 bundled bits {b0&b1, b2&b3, b4&b5, b6&b7} may be obtained. Since the unified number of bits for the second type DCI format is 5, one padding bit may be added. For example, the final HARQ-ACK bits for the second type DCI format may be {b0&b1, b2&b3, b4&b5, b6&b7, NACK}.

In some embodiments, every 2 consecutive bits of the generated HARQ-ACK information bits may be iteratively bundled to a single bit until the number of bundled bits is less than or equal to the value of O. For example, in a first step, every 2 consecutive bits of the generated x bits may be bundled to a single bit, so that ┌x/2┐ bundled bits are generated. If O=┌x/2┐, the final O HARQ-ACK bits for the second type DCI format are obtained. If O<┌x/2┐, then every 2 consecutive bundled bits may be further bundled so that ┌┌x/2┐/2┐ bundled bits are further generated. If O<┌┌x/2┐/2┐, then continue performing the bundling between 2 consecutive bundled bits until the number of generated bundled bits is less than or equal to the value of O, for example, O≥┌┌x/2┐/2┐. If O>┌┌x/2┐/2┐, padding bits (e.g., NACK bits) may be added to the ┌┌x/2┐/2┐ bundled bits such that the number of bundled bits plus the padding bits is equal to the value of O.

For example, assuming that x=8, and {b0, b1, b2, b3, b4, b5, b6, b7} are the generated x HARQ-ACK information bits, when O=5, after a first 2-bit bundling, 4 bundled bits {b0&b1, b2&b3, b4&b5, b6&b7} may be generated. Since the unified number of bits for the second type DCI format is 5, one padding bit is needed to align the size of 5. For example, the final HARQ-ACK bits for the second type DCI format may be {b0&b1, b2&b3, b4&b5, b6&b7, NACK}.

In some embodiments, a number of bits (e.g., (x−O+1) bits) of the generated HARQ-ACK information bits may be bundled to a single bit while the remaining bits of the generated HARQ-ACK information bits are kept unbundled to obtain O HARQ-ACK information bits. The (x−O+1) bits may be located at a predefined position of the generated HARQ-ACK information bits. For example, the (x−O+1) bits may be the starting or last (x−O+1) bits of the generated HARQ-ACK information bits. The remaining (O−1) bits of the generated HARQ-ACK information bits are not bundled so that the total number of bits after bundling is equal to O.

For example, assuming that x=8, {b0, b1, b2, b3, b4, b5, b6, b7} are the generated x HARQ-ACK information bits and O=5, the last 4 bits may be bundled to one bit. The final HARQ-ACK bits for the second type DCI format may be {b0, b1, b2, b3, b4&b5&b6&b7}.

In some embodiments, different bundling methods may be employed depending on the value of O. For example, when the value of O is greater than a threshold (e.g., O>┌x/2┐), which suggests that the number of bits to be bundled is relatively small, a number of bits (e.g., (x−O+1) bits) of the generated x HARQ-ACK information bits may be bundled to a single bit while the remaining bits of the generated HARQ-ACK information bits are kept unbundled to obtain O bits. The (x−O+1) bits may be located at a predefined position of the generated HARQ-ACK information bits. For example, the (x−O+1) bits may be the starting or last (x−O+1) bits of the generated HARQ-ACK information bits. The above bundling method, i.e., some bits are bundled to a single bit while the remaining bit are unbundled to obtain a desired number of bits, may be referred to as bundling method #1.

When the value of O is less than or equal to the threshold (e.g., O≤┌x/2┐), every 2 consecutive bits of the generated x HARQ-ACK information bits may be bundled to a single bit so that ┌x/2┐ bundled bits are generated. The above bundling method, i.e., every 2 consecutive bits may be bundled to a single bit, may be referred to as bundling method #2. If O=┌x/2┐, the final O HARQ-ACK bits for the second type DCI format are obtained. If O<┌x/2┐, an additional bundling method (e.g., bundling method #1 or bundling method #2) may be further performed among the bundled bits (e.g., ┌x/2┐ bundled bits) until the 0 bits can accommodate the further bundled bits. In other words, the value of O is greater than or equal to the bit number of the further bundled bits.

For example, if 0>┌┌x/2┐/2┐, bundling method #1 may be performed among the ┌x/2┐ bundled bits. For instance, the starting or the last (┌x/2┐−O+1) bits of the ┌x/2┐ bundled bits may be bundled to a single bit and the remaining (O−1) bits are not bundled so that the total number of bundled bits is equal to O. If O≤┌┌x/2┐/2┐, bundling method #2 may be performed among the ┌x/2┐ bundled bits. For instance, every 2 consecutive bits of the ┌x/2┐ bundled bits may be bundled to a single bit to obtain ┌┌x/2┐/2┐ bundled bits. If O=┌┌x/2┐/2┐, the final O HARQ-ACK bits for the second type DCI format are obtained. If O<┌┌x/2┐/2┐, an additional bundling method (e.g., bundling method #1 or bundling method #2) may be further performed until the 0 bits can accommodate the further bundled bits.

For example, it is assuming that x=8, {b0, b1, b2, b3, b4, b5, b6, b7} are the generated x HARQ-ACK information bits and O=3. Since O<┌x/2┐, in a first step, every 2 consecutive bits of the x bits may be bundled to a single bit to generate 4 bundled bits, e.g., {b0&b1, b2&b3, b4&b5, b6&b7}. Since O>┌┌x/2┐/2┐, assuming the last 2 bits (4−3+1) are bundled to one bit, the final HARQ-ACK bits for the second type DCI format may be {b0&b1, b2&b3, b4&b5&b6&b7}.

According to the above methods, the HARQ-ACK codebook for the plurality of DCI formats including the first HARQ-ACK sub-codebook and the second HARQ-ACK sub-codebook can be generated to avoid any HARQ-ACK codebook ambiguity.

In some embodiments, the UE may receive a semi-persistent scheduling (SPS) PDSCH and may transmit HARQ-ACK feedback corresponding to the SPS PDSCH in the HARQ-ACK codebook for the plurality of DCI formats.

In some embodiments, the HARQ-ACK information bit(s) for the SPS PDSCH may be placed at a predefined position (e.g., at the end or beginning) of the first sub-codebook or at the end or beginning of the HARQ-ACK codebook.

In some embodiments, the HARQ-ACK information bits for the SPS PDSCH may be placed at a predefined position (e.g., at the end or beginning) of the second sub-codebook with the number of HARQ-ACK information bits for the SPS PDSCH aligned with the unified number (e.g., O) of HARQ-ACK information bits per second type DCI format. For example, when an SPS PDSCH is transmitted on a carrier configured with a CBG-based transmission, the bit number of the CBG-based HARQ-ACK information bits corresponding to the SPS PDSCH may be firstly aligned to O, and then the O HARQ-ACK information bits for the SPS PDSCH may be placed at the end or the beginning of the second sub-codebook.

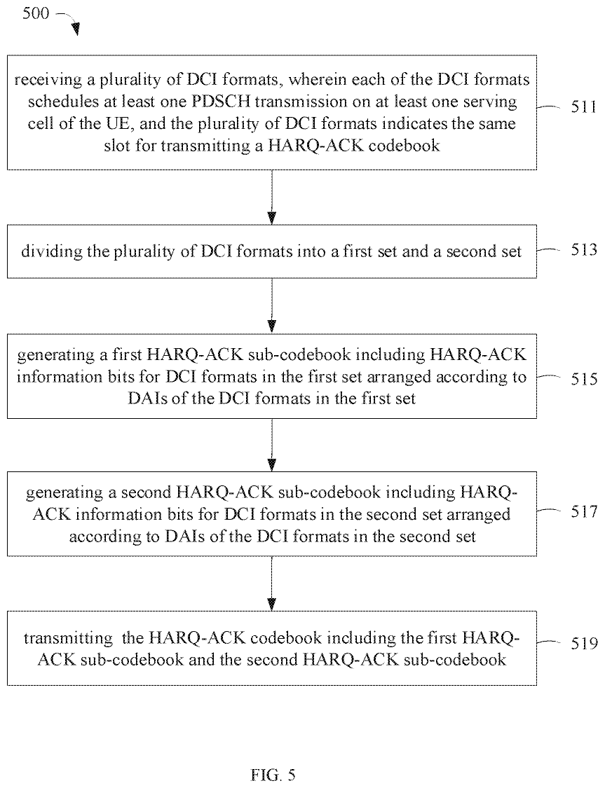

FIG. 4 illustrates a schematic diagram of HARQ-ACK codebook determination in accordance with some embodiments of the present disclosure. Details described in all of the foregoing embodiments of the present disclosure are applicable for the embodiments shown in FIG. 4.

For example, in FIG. 4, DCI formats 411-414 are first type DCI formats and DCI formats 415-418 are second type DCI formats. DCI formats 411-418 may be transmitted on a single carrier or multiple carriers. A UE may generate a sub-codebook for DCI formats 411-414 and a sub-codebook for DCI formats 415-418 according to the above methods. The two sub-codebooks may be concatenated and transmitted in PUCCH 431.

FIG. 5 illustrates a flow chart of an exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a UE, for example, UE 101 in FIG. 1.

Referring to FIG. 5, in operation 511, a UE may receive a plurality of DCI formats. Each of the DCI formats may schedule at least one PDSCH transmission on at least one serving cell of the UE. The plurality of DCI formats may indicate the same slot for transmitting a HARQ-ACK codebook.

In operation 513, the UE may divide the plurality of DCI formats into a first set and a second set. The first set may include all first type DCI formats of the plurality of DCI formats and the second set may include all second type DCI formats of the plurality of DCI formats. The definitions of the first and type DCI formats as describe in the foregoing embodiments can apply here. DAIs may be counted independently for the first type DCI format and the second type DCI format.

For example, each first type DCI format may require a single HARQ-ACK information bit. For instance, the first type DCI format may be from a group of DCI formats including the following: a fallback DCI format; and a non-fallback DCI format transmitted on a carrier not configured with a CBG based transmission, wherein the carrier is configured with a TDRA table with each entry indicating a single SLIV, or the carrier is configured with a TDRA table with at least one entry indicating a plurality of SLIVs and a single PDSCH is scheduled by the non-fallback DCI format, or the carrier is configured with a maximum of two TBs per PDSCH and spatial bundling is applied.

For example, each second type DCI format may require more than one HARQ-ACK information bit. For instance, the second type DCI format may be from a group of DCI formats including the following: a non-fallback DCI format transmitted on a carrier configured with a CBG based transmission, or a carrier configured with a TDRA table with at least one entry indicating a plurality of SLIVs and at least two PDSCHs are scheduled by the non-fallback DCI format, or a carrier configured with a maximum of two TBs per PDSCH and no spatial bundling is applied.

In operation 515, the UE may generate a first HARQ-ACK sub-codebook including HARQ-ACK information bits for DCI formats in the first set arranged according to DAIs of the DCI formats in the first set.

In operation 517, the UE may generate a second HARQ-ACK sub-codebook including HARQ-ACK information bits for DCI formats in the second set arranged according to DAIs of the DCI formats in the second set. For example, the HARQ-ACK information bits for different DCI formats may be arranged according to an ascending or descending order of the DAIs of the respective DCI formats. Each DCI format in the second set, i.e., the second type DCI format, may correspond to a unified number (e.g., O) of HARQ-ACK information bits.

The UE may determine the unified number of HARQ-ACK information bits per second type DCI format in the second set according to various methods.

In some embodiments, the unified number may be determined based on a scaling factor (e.g., φ, a maximum number of PDSCHs schedulable by a DCI format (e.g., M), and a configured maximum number of CBGs per TB (e.g., N). In some examples, the value of the scaling factor may be configured by RRC signaling. In some examples, the value of the scaling factor may be determined based on the configured maximum number of PDSCHs schedulable by a DCI format (e.g., ρ=1/M). In some examples, the value of the scaling factor may be determined based on a TDRA table associated with the second set. In some embodiments, the unified number may be configured by RRC signaling. In some embodiments, the value of the unified number may be equal to the minimum value of a maximum number of PDSCHs schedulable by a DCI format and a configured maximum number of CBGs per TB (e.g., O=min(M, N)).

In some embodiments, to generate the second HARQ-ACK sub-codebook, the UE may generate HARQ-ACK information bits for a DCI format in the second set. In response to the number of the generated HARQ-ACK information bits (e.g., x) for the DCI format being greater than the unified number of HARQ-ACK information bits, the UE may perform HARQ-ACK bundling such that the unified number of HARQ-ACK information bits (e.g., O) accommodate the generated HARQ-ACK information bits for the DCI format. In other words, a HARQ-ACK bundling procedure may be performed to align the x bits to O bits.

In some embodiments, to perform the HARQ-ACK bundling, the UE may bundle every first number (e.g., Z) consecutive bits of the generated HARQ-ACK information bits (e.g., x bits) to a single bit. The first number may be determined based on the number of the generated HARQ-ACK information bits and the unified number. For example, the value of the first number may be the minimum integer which is greater than or equal to the quotient of the number of the generated HARQ-ACK information bits divided by the unified number. For instance, z=┌x/O┌.

In some embodiments, to perform the HARQ-ACK bundling, the UE may iteratively bundle every 2 consecutive bits of the generated HARQ-ACK information bits to a single bit until the number of bundled bits is less than or equal to the unified number.

In some embodiments, to perform the HARQ-ACK bundling, the UE may bundle a second number of bits of the generated HARQ-ACK information bits to a single bit while keeping the remaining bits of the generated HARQ-ACK information bits unbundled to obtain the unified number of HARQ-ACK information bits. The value of the second number may be the sum of one and the difference between the number of the generated HARQ-ACK information bits and the unified number (e.g., equal to (x−O+1)). The second number of bits may be located at a predefined position of the generated HARQ-ACK information bits. For example, the second number of bits may be the starting or last second number of bits of the generated HARQ-ACK information bits.

In some embodiments, to perform the HARQ-ACK bundling, the UE may perform different bundling methods according to the value of the unified number.

For example, in response to the unified number of HARQ-ACK information bits being greater than a third number of bits, the UE may bundle the second number of bits (e.g., (x−O+1) bits) of the generated HARQ-ACK information bits to a single bit while keeping the remaining bits of the generated HARQ-ACK information bits unbundled to obtain the unified number of HARQ-ACK information bits. The value of the third number may be equal to the minimum integer which is greater than or equal to the quotient of the number of the generated HARQ-ACK information bits divided by 2. For example, when O>┌x/2┐, the UE may bundle (x−O+1) bits of the x bits to a single bit while keeping the remaining 0-1 bits unbundled to obtain O HARQ-ACK information bits to be included in the second sub-codebook.

In response to the unified number of HARQ-ACK information bits being less than or equal to the third number of bits, the UE may bundle every 2 consecutive bits of the generated HARQ-ACK information bits to a single bit to obtain the third number of bits. For example, when O≤┌x/2┐, the UE may bundle every 2 consecutive bits of the x bits to a single bit to obtain ┌x/2┐ bits. A bit bundling procedure may be further performed among the third number of bits until the unified number of HARQ-ACK information bits can accommodate the bundled bits. For example, when O<┌x/2┐, additional bit bundling procedure may be performed on the ┌x/2┐ bits.

Various methods may be employed to perform the bit bundling procedure among the third number of bits. In some embodiments, in response to the unified number of HARQ-ACK information bits being greater than a fourth number of bits, the UE may bundle a fifth number of bits of the third number of bits to a single bit while keeping the remaining bits of the third number of bits unbundled to obtain the unified number of HARQ-ACK information bits. In response to the unified number of HARQ-ACK information bits being less than or equal to the fourth number of bits, the UE may bundle every 2 consecutive bits of the third number of bits to a single bit to obtain the fourth number of bits. The UE may similarly perform the bit bundling procedure among the fourth number of bits until the unified number of HARQ-ACK information bits accommodate the bundled bits. The value of the fourth number may be equal to the minimum integer which is greater than or equal to the quotient of the third number divided by 2 (e.g., ┌┌x/2┐/2┐). The value of the fifth number may be the sum of one and the difference between the third number and the unified number (e.g., (┌x/2┐−O+1)).

In some embodiments, the UE may pad the bundled HARQ-ACK information bits for the DCI format with at least one padding bit (e.g., at least one NACK bit) such that the sum of the number of the bundled HARQ-ACK information bits and the number of the at least one padding bit is equal to the unified number.

In operation 519, the UE may transmit the HARQ-ACK codebook including the first HARQ-ACK sub-codebook and the second HARQ-ACK sub-codebook.

In some embodiments, the UE may receive an SPS PDSCH and may transmit HARQ-ACK feedback corresponding to the SPS PDSCH in the HARQ-ACK codebook. In some examples, a HARQ-ACK information bit(s) for the SPS PDSCH may be placed at a predefined location (e.g., at the end or beginning) of the first sub-codebook or a predefined location (e.g., at the end or beginning) of the HARQ-ACK codebook. In some examples, the HARQ-ACK information bits for the SPS PDSCH may be placed at a predefined location (e.g., at the end or beginning) of the second sub-codebook with the number of HARQ-ACK information bits for the SPS PDSCH aligned with the unified number of HARQ-ACK information bits per second type DCI format in the second set.

It should be appreciated by persons skilled in the art that the sequence of the operations in exemplary procedure 500 may be changed and some of the operations in exemplary procedure 500 may be eliminated or modified, without departing from the spirit and scope of the disclosure.

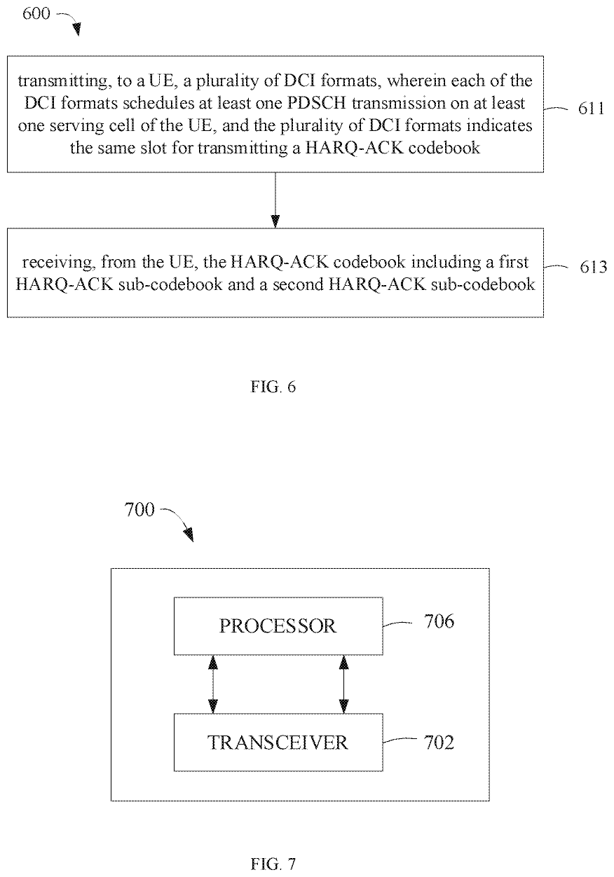

FIG. 6 illustrates a flow chart of an exemplary procedure 600 for wireless communications in accordance with some embodiments of the present disclosure. Details described in all of the foregoing embodiments of the present disclosure are applicable for the embodiments shown in FIG. 6. In some examples, the procedure may be performed by a BS, for example, BS 102 in FIG. 1.

Referring to FIG. 6, in operation 611, a BS may transmit, to a UE, a plurality of DCI formats. Each of the DCI formats may schedule at least one PDSCH transmission on at least one serving cell of the UE, and the plurality of DCI formats may indicate the same slot for transmitting a HARQ-ACK codebook.

The plurality of DCI formats may be divided into a first set and a second set. The first set may include all first type DCI formats of the plurality of DCI formats and the second set may include all second type DCI formats of the plurality of DCI formats. The definitions of the first and type DCI formats as describe in the foregoing embodiments can apply here. DAIs may be counted independently for the first type DCI format and the second type DCI format.

For example, each first type DCI format may require a single HARQ-ACK information bit. For instance, the first type DCI format may be from a group of DCI formats including the following: a fallback DCI format; and a non-fallback DCI format transmitted on a carrier not configured with a CBG based transmission, wherein the carrier is configured with a TDRA table with each entry indicating a single SLIV, or the carrier is configured with a TDRA table with at least one entry indicating a plurality of SLIVs and a single PDSCH is scheduled by the non-fallback DCI format, or the carrier is configured with a maximum of two TBs per PDSCH and spatial bundling is applied.

For example, each second type DCI format may require more than one HARQ-ACK information bit. For instance, the second type DCI format may be from a group of DCI formats including the following: a non-fallback DCI format transmitted on a carrier configured with a CBG based transmission, or a carrier configured with a TDRA table with at least one entry indicating a plurality of SLIVs and at least two PDSCHs are scheduled by the non-fallback DCI format, or a carrier configured with a maximum of two TBs per PDSCH and no spatial bundling is applied.

In operation 613, the BS may receive, from the UE, the HARQ-ACK codebook including a first HARQ-ACK sub-codebook and a second HARQ-ACK sub-codebook. The first HARQ-ACK sub-codebook may include HARQ-ACK information bits for DCI formats in the first set arranged according to DAIs of the DCI formats in the first set, and the second HARQ-ACK sub-codebook may include HARQ-ACK information bits for DCI formats in the second set arranged according to DAIs of the DCI formats in the second set.

In some embodiments of the present disclosure, the BS may determine a unified number of HARQ-ACK information bits per second type DCI format in the second set. The methods for determining the unified number as describe in the foregoing embodiments can apply here. In some embodiments, the unified number may be determined based on a scaling factor, the maximum number of PDSCHs schedulable by a DCI format, and the maximum number of CBGs per TB. In some examples, the scaling factor may be determined based on a probability of single-PDSCH scheduling. The processor may be further configured to transmit the scaling factor to the UE via RRC signaling. In some examples, the scaling factor may be determined based on the maximum number of PDSCHs schedulable by a DCI format. In some examples, the scaling factor may be determined based on a TDRA table associated with the second set. In some embodiments, the BS may transmit the unified number to the UE via radio RRC signaling. In some embodiments, the value of the unified number is equal to the minimum value of the maximum number of PDSCHs schedulable by a DCI format and the maximum number of CBGs per TB.

The BS may determine, for each DCI format in the second set, a plurality of HARQ-ACK information bits for a corresponding DCI format in the second set from the second HARQ-ACK sub-codebook, wherein the size of the plurality of HARQ-ACK information bits is equal to the unified number.

In response to the corresponding DCI format scheduling a single PDSCH and the number of CBGs of the single PDSCH being greater than the unified number, or in response to the corresponding DCI format scheduling more than one PDSCH and the number of the more than one PDSCH being greater than the unified number, a HARQ-ACK bundling procedure may be performed on HARQ-ACK feedback for the corresponding DCI format to obtain the plurality of HARQ-ACK information bits. The HARQ-ACK bundling procedure as describe in the foregoing embodiments can apply here.

For example, in some embodiments, during the HARQ-ACK bundling procedure, every first number consecutive bits of the HARQ-ACK feedback for the corresponding DCI format may be bundled to a single bit. The first number may be determined based on the number of bits of the HARQ-ACK feedback for the corresponding DCI format and the unified number. For example, the value of the first number may be the minimum integer which is greater than or equal to the quotient of the number of bits of the HARQ-ACK feedback for the corresponding DCI format divided by the unified number.

In some embodiments, during the HARQ-ACK bundling procedure, every 2 consecutive bits of the HARQ-ACK feedback for the corresponding DCI format may be iteratively bundled to a single bit until the number of bundled bits is less than or equal to the unified number.

In some embodiments, during the HARQ-ACK bundling procedure, a second number of bits of the HARQ-ACK feedback for the corresponding DCI format may be bundled to a single bit while the remaining bits of the HARQ-ACK feedback for the corresponding DCI format are kept unbundled to obtain the unified number of HARQ-ACK information bits. The second number may be the sum of one and the difference between the number of bits of the HARQ-ACK feedback for the corresponding DCI format and the unified number. The second number of bits may be located at a predefined location. For example, the second number of bits may be the starting or last second number of bits of the HARQ-ACK feedback for the corresponding DCI format.

In some embodiments, during the HARQ-ACK bundling procedure, in response to the unified number of HARQ-ACK information bits being greater than a third number of bits, the second number of bits of the HARQ-ACK feedback for the corresponding DCI format may be bundled to a single bit while the remaining bits of the HARQ-ACK feedback for the corresponding DCI format are kept unbundled to obtain the unified number of HARQ-ACK information bits. In response to the unified number of HARQ-ACK information bits being less than or equal to the third number of bits, every 2 consecutive bits of the HARQ-ACK feedback for the corresponding DCI format may be bundled to a single bit to obtain the third number of bits. A bit bundling procedure as descried above may be performed among the third number of bits until the unified number of HARQ-ACK information bits can accommodate the bundled bits. The value of the third number may be equal to the minimum integer which is greater than or equal to the quotient of the number of the generated HARQ-ACK information bits divided by 2.

In some embodiments, during the bit bundling procedure among the third number of bits, in response to the unified number of HARQ-ACK information bits being greater than a fourth number of bits, a fifth number of bits of the third number of bits may be bundled to a single bit while the remaining bits of the third number of bits are kept unbundled to obtain the unified number of HARQ-ACK information bits. The value of the fourth number may be equal to the minimum integer which is greater than or equal to the quotient of the third number divided by 2. The value of the fifth number may be the sum of one and the difference between the third number and the unified number. During the bit bundling procedure among the third number of bits, in response to the unified number of HARQ-ACK information bits being less than or equal to the fourth number of bits, every 2 consecutive bits of the third number of bits may be bundled to a single bit to obtain the fourth number of bits. A bit bundling procedure as descried above may be performed among the fourth number of bits until the unified number of HARQ-ACK information bits can accommodate the bundled bits.

In some embodiments, the plurality of HARQ-ACK information bits may include at least one padding bit such that the sum of the number of the bundled HARQ-ACK information bits for the corresponding DCI format and the number of the at least one padding bit is equal to the unified number.

In some embodiments, the BS may transmit an SPS PDSCH to the UE. The BS may receive HARQ-ACK feedback corresponding to the SPS PDSCH in the HARQ-ACK codebook associated with the plurality of DCI formats.

In some embodiments, the HARQ-ACK information bit(s) for the SPS PDSCH may be placed at a predefined location (e.g., at the end or beginning) of the first sub-codebook or at a predefined location (e.g., at the end or beginning) of the HARQ-ACK codebook. In some embodiments, the HARQ-ACK information bits for the SPS PDSCH may be placed at a predefined location (e.g., at the end or beginning) of the second sub-codebook with the number of HARQ-ACK information bits for the SPS PDSCH aligned with the unified number of HARQ-ACK information bits per second type DCI format in the second set.

It should be appreciated by persons skilled in the art that the sequence of the operations in exemplary procedure 600 may be changed and some of the operations in exemplary procedure 600 may be eliminated or modified, without departing from the spirit and scope of the disclosure.

FIG. 7 illustrates a block diagram of an exemplary apparatus 700 according to some embodiments of the present disclosure. As shown in FIG. 7, the apparatus 700 may include at least one processor 706 and at least one transceiver 702 coupled to the processor 706. The apparatus 700 may be a UE or a BS.

Although in this figure, elements such as the at least one transceiver 702 and processor 706 are described in the singular, the plural is contemplated unless a limitation to the singular is explicitly stated. In some embodiments of the present application, the transceiver 702 may be divided into two devices, such as a receiving circuitry and a transmitting circuitry. In some embodiments of the present application, the apparatus 700 may further include an input device, a memory, and/or other components.

In some embodiments of the present application, the apparatus 700 may be a UE. The transceiver 702 and the processor 706 may interact with each other so as to perform the operations with respect to the UE described in FIGS. 1-6. In some embodiments of the present application, the apparatus 700 may be a BS. The transceiver 702 and the processor 706 may interact with each other so as to perform the operations with respect to the BS described in FIGS. 1-6.

In some embodiments of the present application, the apparatus 700 may further include at least one non-transitory computer-readable medium.

For example, in some embodiments of the present disclosure, the non-transitory computer-readable medium may have stored thereon computer-executable instructions to cause the processor 706 to implement the method with respect to the UE as described above. For example, the computer-executable instructions, when executed, cause the processor 706 interacting with transceiver 702, so as to perform the operations with respect to the UE described in FIGS. 1-6.

In some embodiments of the present disclosure, the non-transitory computer-readable medium may have stored thereon computer-executable instructions to cause the processor 706 to implement the method with respect to the BS as described above. For example, the computer-executable instructions, when executed, cause the processor 706 interacting with transceiver 702 to perform the operations with respect to the BS described in FIGS. 1-6.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive a plurality of downlink control information (DCI) formats, wherein each of the DCI formats schedules at least one physical downlink shared channel (PDSCH) transmission on at least one serving cell of the UE, and the plurality of DCI formats indicates a same slot for transmitting a hybrid automatic repeat request acknowledgement (HARQ-ACK) codebook;
divide the plurality of DCI formats into a first set and a second set, wherein the first set includes all first type DCI formats of the plurality of DCI formats and the second set includes all second type DCI formats of the plurality of DCI formats, wherein each first type DCI format requires a single HARQ-ACK information bit and each second type DCI format requires more than one HARQ-ACK information bit, and wherein downlink assignment indicators (DAIs) are counted independently for the first type DCI format and the second type DCI format;
generate a first HARQ-ACK sub-codebook comprising HARQ-ACK information bits for DCI formats in the first set arranged according to DAIs of the DCI formats in the first set;
generate a second HARQ-ACK sub-codebook comprising HARQ-ACK information bits for DCI formats in the second set arranged according to DAIs of the DCI formats in the second set; and
transmit the HARQ-ACK codebook comprising the first HARQ-ACK sub-codebook and the second HARQ-ACK sub-codebook.

2. The UE of claim 1, wherein the first type DCI format is from a group of DCI formats including the following:
a fallback DCI format; and
a non-fallback DCI format transmitted on a carrier not configured with a code block group (CBG) based transmission, wherein the carrier is configured with a time domain resource allocation (TDRA) table with each entry indicating a single start and length indicator value (SLIV), or the carrier is configured with a TDRA table with at least one entry indicating a plurality of SLIVs and a single PDSCH is scheduled by the non-fallback DCI format, or the carrier is configured with a maximum of two transport blocks (TBs) per PDSCH and spatial bundling is applied.

3. The UE of claim 1, wherein the second type DCI format is from a group of DCI formats including the following:
a non-fallback DCI format transmitted on a carrier configured with a code block group (CBG) based transmission, or a carrier configured with a time domain resource allocation (TDRA) table with at least one entry indicating a plurality of start and length indicator values (SLIVs) and at least two PDSCHs are scheduled by the non-fallback DCI format, or a carrier configured with a maximum of two transport blocks (TBs) per PDSCH and no spatial bundling is applied.

4. The UE of claim 1, wherein the at least one processor is configured to cause the UE to determine a unified number of HARQ-ACK information bits per second type DCI format in the second set.

5. The UE of claim 4, wherein the unified number is determined based on a scaling factor, a configured maximum number of PDSCHs schedulable by a DCI format, and a configured maximum number of code block groups (CBGs) per transport block (TB); or
wherein the unified number is configured by radio resource control (RRC) signaling; or
wherein a value of the unified number is equal to the minimum value of a configured maximum number of PDSCHs schedulable by a DCI format and a configured maximum number of code block groups (CBGs) per transport block (TB).

6. The UE of claim 5, wherein the value of the scaling factor is configured by radio resource control (RRC) signaling, or determined based on the configured maximum number of PDSCHs schedulable by a DCI format, or determined based on a time domain resource allocation (TDRA) table associated with the second set.

7. The UE of claim 4, wherein to generate the second HARQ-ACK sub-codebook, the at least one processor is configured to cause the UE to:
generate HARQ-ACK information bits for a DCI format in the second set; and
in response to the number of the generated HARQ-ACK information bits for the DCI format being greater than the unified number of HARQ-ACK information bits, perform HARQ-ACK bundling such that the unified number of HARQ-ACK information bits accommodate the generated HARQ-ACK information bits for the DCI format.

8. The UE of claim 7, wherein to perform the HARQ-ACK bundling, the at least one processor is configured to cause the UE perform one of the following:
bundle every first number consecutive bits of the generated HARQ-ACK information bits to a single bit, wherein the first number is determined based on the number of the generated HARQ-ACK information bits and the unified number;
iteratively bundle every 2 consecutive bits of the generated HARQ-ACK information bits to a single bit until the number of bundled bits is less than or equal to the unified number;
bundle a second number of bits of the generated HARQ-ACK information bits to a single bit while keeping the remaining bits of the generated HARQ-ACK information bits unbundled to obtain the unified number of HARQ-ACK information bits; and
in response to the unified number of HARQ-ACK information bits being greater than a third number of bits, bundle the second number of bits of the generated HARQ-ACK information bits to a single bit while keeping the remaining bits of the generated HARQ-ACK information bits unbundled to obtain the unified number of HARQ-ACK information bits; and in response to the unified number of HARQ-ACK information bits being less than or equal to the third number of bits, bundle every 2 consecutive bits of the generated HARQ-ACK information bits to a single bit to obtain the third number of bits and perform a bit bundling procedure among the third number of bits until the unified number of HARQ-ACK information bits accommodate the bundled bits, wherein a value of the third number is equal to the minimum integer which is greater than or equal to a quotient of the number of the generated HARQ-ACK information bits divided by 2.

9. The UE of claim 8, wherein to perform the bit bundling procedure among the third number of bits, the at least one processor is configured to cause the UE to perform one of the following:
in response to the unified number of HARQ-ACK information bits being greater than a fourth number of bits, bundle a fifth number of bits of the third number of bits to a single bit while keeping the remaining bits of the third number of bits unbundled to obtain the unified number of HARQ-ACK information bits, wherein the value of the fourth number is equal to the minimum integer which is greater than or equal to the quotient of the third number divided by 2; and
in response to the unified number of HARQ-ACK information bits being less than or equal to the fourth number of bits, bundle every 2 consecutive bits of the third number of bits to a single bit to obtain the fourth number of bits and perform the bit bundling procedure among the fourth number of bits until the unified number of HARQ-ACK information bits accommodate the bundled bits.

10. The UE of claim 8, wherein the value of the first number is the minimum integer which is greater than or equal to the quotient of the number of the generated HARQ-ACK information bits divided by the unified number.

11. The UE of claim 8, wherein the value of the second number is a sum of one and a difference between the number of the generated HARQ-ACK information bits and the unified number.

12. The UE of claim 8, wherein the second number of bits is a starting or last second number of bits of the generated HARQ-ACK information bits.

13. The UE of claim 7, wherein to generate the second HARQ-ACK sub-codebook, the at least one processor is configured to cause the UE to pad the bundled HARQ-ACK information bits for the DCI format with at least one padding bit such that a sum of the number of the bundled HARQ-ACK information bits and the number of the at least one padding bit is equal to the unified number.

14. The UE of claim 1, wherein the at least one processor is configured to cause the UE to:
receive a semi-persistent scheduling (SPS) PDSCH;
transmit HARQ-ACK feedback corresponding to the SPS PDSCH in the HARQ-ACK codebook;
wherein a HARQ-ACK information bit(s) for the SPS PDSCH is placed at an end or beginning of the first sub-codebook or at an end or beginning of the HARQ-ACK codebook; or
wherein HARQ-ACK information bits for the SPS PDSCH are placed at an end or beginning of the second sub-codebook with a number of HARQ-ACK information bits for the SPS PDSCH aligned with a unified number of HARQ-ACK information bits per second type DCI format in the second set.

15. A base station (BS), comprising:
at least one memory; and
at least one processor coupled with the at least one memory and configured to cause the base station to:
transmit, to a user equipment (UE), a plurality of downlink control information (DCI) formats, wherein each of the DCI formats schedules at least one physical downlink shared channel (PDSCH) transmission on at least one serving cell of the UE, and the plurality of DCI formats indicates a same slot for transmitting a hybrid automatic repeat request acknowledgement (HARQ-ACK) codebook; and
receive, from the UE, the HARQ-ACK codebook comprising a first HARQ-ACK sub-codebook and a second HARQ-ACK sub-codebook,
wherein the plurality of DCI formats is divided into a first set and a second set, the first set includes all first type DCI formats of the plurality of DCI formats and the second set includes all second type DCI formats of the plurality of DCI formats, wherein each first type DCI format requires a single HARQ-ACK information bit and each second type DCI format requires more than one HARQ-ACK information bit, wherein downlink assignment indicators (DAIs) are counted independently for the first type DCI format and the second type DCI format, and
wherein the first HARQ-ACK sub-codebook comprises HARQ-ACK information bits for DCI formats in the first set arranged according to DAIs of the DCI formats in the first set, and the second HARQ-ACK sub-codebook comprises HARQ-ACK information bits for DCI formats in the second set arranged according to DAIs of the DCI formats in the second set.

16. A processor for wireless communication, comprising:
at least one controller coupled with at least one memory and configured to cause the processor to:
receive a plurality of downlink control information (DCI) formats, wherein each of the DCI formats schedules at least one physical downlink shared channel (PDSCH) transmission on at least one serving cell of the processor, and the plurality of DCI formats indicates a same slot for transmitting a hybrid automatic repeat request acknowledgement (HARQ-ACK) codebook;
divide the plurality of DCI formats into a first set and a second set, wherein the first set includes all first type DCI formats of the plurality of DCI formats and the second set includes all second type DCI formats of the plurality of DCI formats, wherein each first type DCI format requires a single HARQ-ACK information bit and each second type DCI format requires more than one HARQ-ACK information bit, and wherein downlink assignment indicators (DAIs) are counted independently for the first type DCI format and the second type DCI format;
generate a first HARQ-ACK sub-codebook comprising HARQ-ACK information bits for DCI formats in the first set arranged according to DAIs of the DCI formats in the first set;
generate a second HARQ-ACK sub-codebook comprising HARQ-ACK information bits for DCI formats in the second set arranged according to DAIs of the DCI formats in the second set; and
transmit the HARQ-ACK codebook comprising the first HARQ-ACK sub-codebook and the second HARQ-ACK sub-codebook.

17. A method performed by a user equipment (UE), the method comprising:
receiving a plurality of downlink control information (DCI) formats, wherein each of the DCI formats schedules at least one physical downlink shared channel (PDSCH) transmission on at least one serving cell of the UE, and the plurality of DCI formats indicates a same slot for transmitting a hybrid automatic repeat request acknowledgement (HARQ-ACK) codebook;
dividing the plurality of DCI formats into a first set and a second set, wherein the first set includes all first type DCI formats of the plurality of DCI formats and the second set includes all second type DCI formats of the plurality of DCI formats, wherein each first type DCI format requires a single HARQ-ACK information bit and each second type DCI format requires more than one HARQ-ACK information bit, and wherein downlink assignment indicators (DAIs) are counted independently for the first type DCI format and the second type DCI format;
generating a first HARQ-ACK sub-codebook comprising HARQ-ACK information bits for DCI formats in the first set arranged according to DAIs of the DCI formats in the first set;
generating a second HARQ-ACK sub-codebook comprising HARQ-ACK information bits for DCI formats in the second set arranged according to DAIs of the DCI formats in the second set; and
transmitting the HARQ-ACK codebook comprising the first HARQ-ACK sub-codebook and the second HARQ-ACK sub-codebook.

18. The processor of claim 16, wherein the first type DCI format is from a group of DCI formats including the following:
a fallback DCI format; and
a non-fallback DCI format transmitted on a carrier not configured with a code block group (CBG) based transmission, wherein the carrier is configured with a time domain resource allocation (TDRA) table with each entry indicating a single start and length indicator value (SLIV), or the carrier is configured with a TDRA table with at least one entry indicating a plurality of SLIVs and a single PDSCH is scheduled by the non-fallback DCI format, or the carrier is configured with a maximum of two transport blocks (TBs) per PDSCH and spatial bundling is applied.

19. The processor of claim 16, wherein the second type DCI format is from a group of DCI formats including the following:
a non-fallback DCI format transmitted on a carrier configured with a code block group (CBG) based transmission, or a carrier configured with a time domain resource allocation (TDRA) table with at least one entry indicating a plurality of start and length indicator values (SLIVs) and at least two PDSCHs are scheduled by the non-fallback DCI format, or a carrier configured with a maximum of two transport blocks (TBs) per PDSCH and no spatial bundling is applied.

20. The processor of claim 16, wherein the at least one controller is further configured to cause the processor to determine a unified number of HARQ-ACK information bits per second type DCI format in the second set.
